(19) United States
(12) Patent Application Publication
(10) Pub. No.: US 2023/0116086 A1
(43) Pub. Date: Apr. 13, 2023

(54) ROBOTIC POWDER BED CARTS AND COMPATIBLE PRINTER HOUSINGS FOR SLS THREE-DIMENSIONAL PRINTING

(71) Applicant: NEXA3D INC., Ventura, CA (US)

(72) Inventors: Tomasz P. CIESZYNSKI, Ventura, CA (US); Jakub GRACZYK, Santa Barbara, CA (US)

(21) Appl. No.: 17/594,549

(22) PCT Filed: May 7, 2020
(86) PCT No.: PCT/US2020/031895

§ 371 Date: Oct. 21, 2021

Related U.S. Application Data
(60) Provisional application No. 62/847,504, filed on May 14, 2019.

(51) Int. Cl. B29C 64/259; B22F 12/50; B22F 10/28; B22F 12/90; B22F 12/13; B29C 64/153; B29C 64/295; B29C 64/393; B33Y 30/00; B33Y 40/00; B33Y 50/02; B29C 64/321; B22F 12/80; G05D 1/02

(52) U.S. Cl. CPC B29C 64/259; B22F 12/50; B22F 10/28; B22F 12/90; B22F 12/13; B29C 64/153; B29C 64/295; B29C 64/393; B33Y 30/00; B33Y 40/00; B33Y 50/02; B29C 64/321; B22F 12/80; G05D 1/021; G05D 2201/0216; B60L 50/60

(57) ABSTRACT

Multiple printer housings and powder bed carts may be coordinated to perform a variety of 3D printing operations. Printer housings may call for powder bed carts directly or through a control station. A requested powder bed cart may be dispatched from a stand-by area and may navigate to the requesting printer housing autonomously using its magnetic guide sensors to follow lines of magnetic tape on the floor. At the requesting printer housing, the powder bed cart may dock, move the powdered media trays and powder bed into position by elevating on its jack screws, and printing operations may commence. As the powder bed cart becomes depleted of powdered media, the powder bed cart may decouple from the printer housing and return to the stand-by area where the trays are refilled with powdered media, and its batteries are recharged.

### RELATED APPLICATIONS

This application claims priority to U.S. Provisional Application No. 62/847,504, filed 14 May 2019.

### FIELD OF THE INVENTION

The present invention relates to a powder bed carts and associated printer housings for a selective laser sintering (SLS) and, in one embodiment, relates to such carts which includes means for autonomous locomotion and docking with ones of said printer housings.

### BACKGROUND

So-called “3D printing” or, more generally, additive manufacturing, is a broad term used to describe processes to fabricate three-dimensional objects from digital data files under computer control. A number of different additive manufacturing techniques have been developed, including SLS. SLS involves the fusing of material, typically a metal, polymer, or ceramic powder, at points in space defined by a digital model file using a laser. For a given cross-sectional layer of the model, the focal point of the laser is scanned over a bed of powdered material, causing the material to form a solid mass at the points heated, individually, by the laser. After each cross-section is scanned, the powder bed is lowered, a new layer of the material is applied, and the process is repeated. This process continues, point-by-point for each cross-sectional layer of the object under fabrication until the desired object is completed.

### SUMMARY OF THE INVENTION

In accordance with one embodiment of the invention, multiple printer housings and carts may be coordinated to perform a variety of print operations. Printer housings may call for powder bed carts directly or through a control station. A requested powder bed cart may be dispatched from a stand-by area and may navigate to the requesting printer housing autonomously using its magnetic guide sensors to follow lines of magnetic tape on the floor. At the requesting printer housing, the powder bed cart may dock, move the powdered material trays and powder bed into position by elevating on its jack screws, and printing operations may commence. As the powder bed cart becomes depleted of powdered material, the powder bed cart may decouple from the printer housing and return to the stand-by area where the trays are refilled with powdered material, and its batteries are recharged.

A printer housing may include an opening adapted for docking with the powder bed cart. The printer housing may additionally include a laser source configured to generate a laser beam, and an imaging system configured to scan the laser beam over the powdered material disposed in a powder bed of the powder bed cart, causing the powdered material to form a solid mass at points heated by the laser beam. The printer housing may additionally include a roller configured to spread the powdered material within the powder bed.

A powder bed cart may include the powder bed, means for autonomous locomotion, and means for docking with the printing housing. The means for autonomous locomotion may include, location sensors, wheels disposed on an underside of the powder bed cart, an electric motor to steer and propel the powder bed cart to a desired destination, and batteries for powering the electric motor. The means for docking with the printing housing may include vertical adjustment means to raise a vertical position of the powder bed to an operational position within the printer housing.

These and other embodiments of the invention are more fully described in association with the drawings below.

### BRIEF DESCRIPTION OF THE DRAWINGS

FIGS. 1A-1C depict an apparatus for forming a three-dimensional article by fusion of a powdered medium in a powder bed, in accordance with one embodiment of the invention.

FIG. 2 depicts a cart for transporting the powder medium, and a printer housing configured to receive the cart, in accordance with one embodiment of the invention.

FIG. 3A depicts vertical adjustment means for bringing the powder bed and the trays for powdered medium to their operational positions within the printer housing, in accordance with one embodiment of the invention.

FIG. 3B depicts an assembly in which the cart is docked in a printer housing, in accordance with one embodiment of the invention.

FIG. 4 depicts a system that integrates multiple printer housings, carts, and a control station, in accordance with one embodiment of the invention.

FIG. 5 depicts shop floor with multiple printer housings and carts, in accordance with one embodiment of the invention.

### DETAILED DESCRIPTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps.

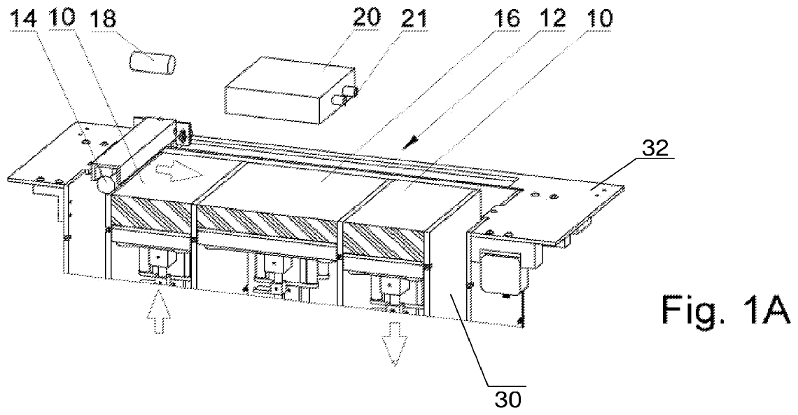

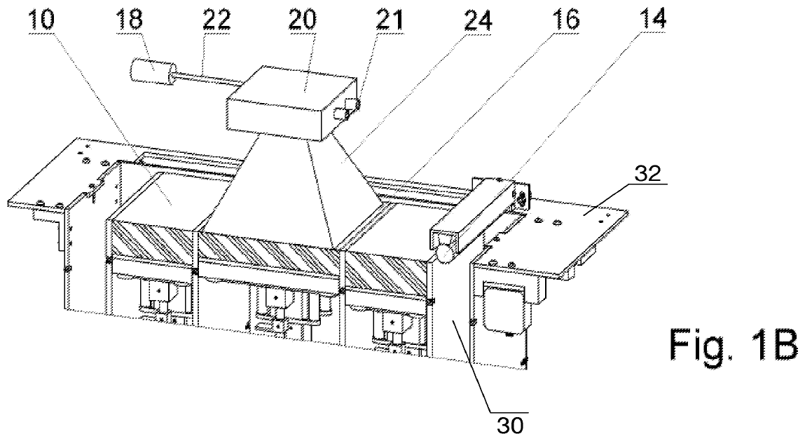

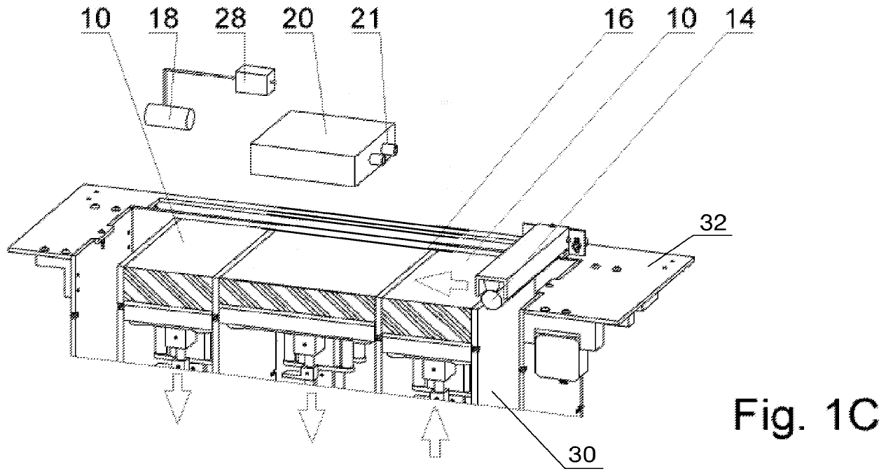

Referring to FIGS. 1A-1C, an example of an apparatus for forming a three-dimensional article by fusion of a powdered medium 10 in a powder bed 12 and steps in the operation of said apparatus are shown. A first layer of a powdered medium 10 (e.g., a metal, polyamide, or other material) is distributed over a powder bed 12. This may be accomplished by spreading the material in a thin layer over the powder bed 12 using a roller motion mechanism 14, or by otherwise depositing the layer over same, so that a relatively thin, uniform layer of the powdered medium 10 is distributed on the powder bed 12. In some instances, the powdered medium 10 may be distributed through gravity feed and then rolled or scraped to form the relatively thin, uniform layer on the powder bed 12.

Once distributed, the relatively thin, uniform layer of powdered medium 10, or at least a portion thereof in a work area 16, may be heated to a temperature below its melting point. This heating may be accomplished in any of a variety of ways, including using infra-red lamps.

As shown in FIG. 1B, an image of a cross-sectional layer of a work piece (i.e., an object to be fabricated) is focused on the layer of the powdered medium distributed over the work area 16 of powder bed 12, using a laser source 18 and imaging system 20. In general, this involves scanning the focal point of the laser beam 22 over the bed of powdered material, causing the material to form a solid mass at the points heated by the laser. The laser beam has sufficient energy to fuse that portion of the powdered medium 10 in locations in the work area 16 of the powder bed 12 corresponding to the image of the first cross-sectional layer of the object to be fabricated to form an integral layer of the powdered medium having a shape corresponding to that image of the first cross-sectional layer of the object. Other portions of the powdered medium on the powder bed remain unfused and surround the integral or fused portion of the layer of powdered medium, supporting it.

Next, as shown in FIG. 1C, the powder bed 12 is lowered, and a second layer of the powdered medium 10 is distributed over the first layer (e.g., using roller 14), and the foregoing process is repeated using an image of a second cross-sectional layer of the object to be fabricated, to form an integral layer of the powdered medium having a shape corresponding thereto. This process may be repeated for additional layers of the powdered medium, each being distributed over immediately preceding layers thereof, and additional images of respective additional cross-sectional layer of the object, so as to form the three-dimensional article.

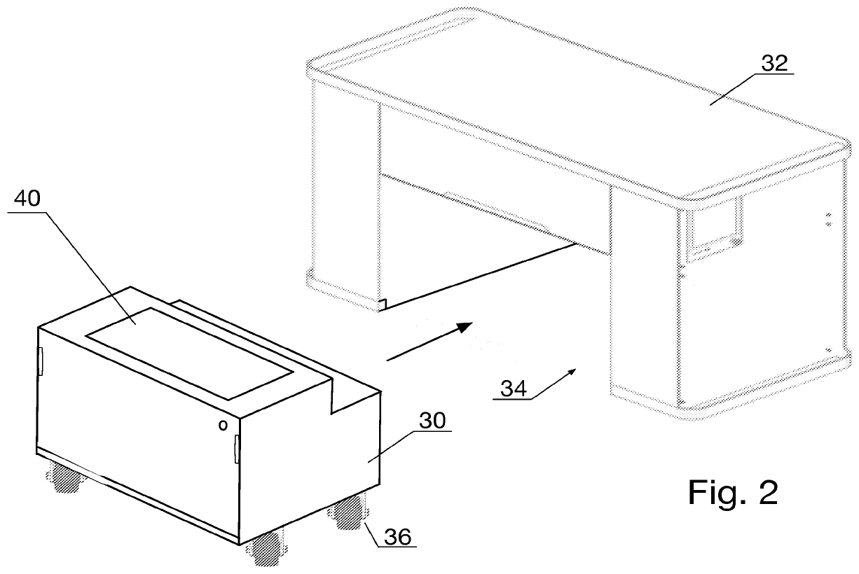

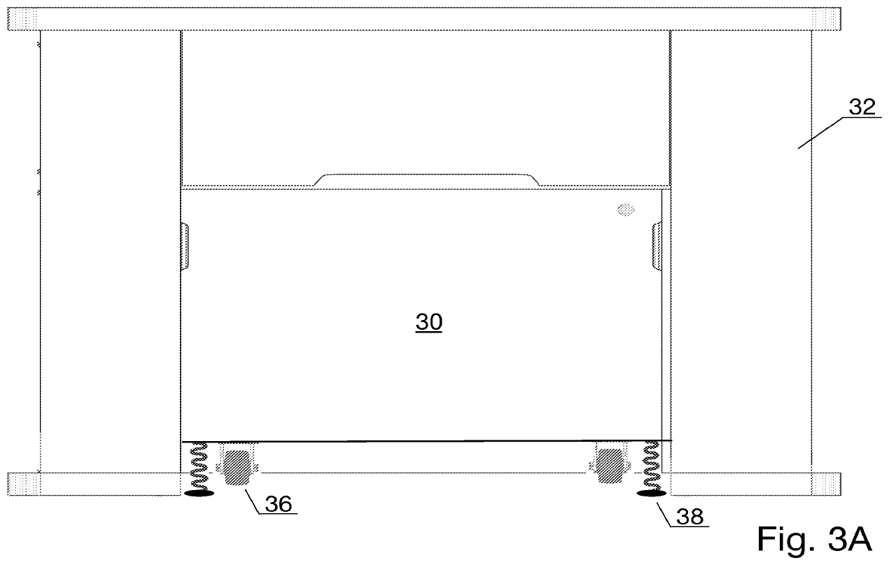

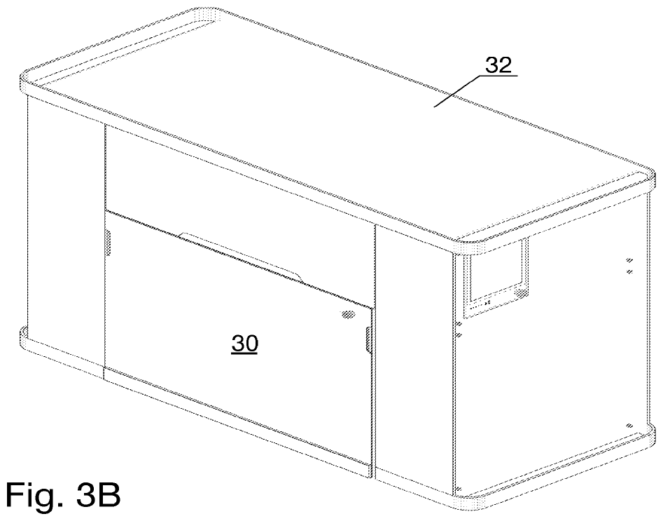

In FIGS. 1A-1C, the powder bed 12 and the trays for powdered medium 10 (with powdered media therein) on either side thereof are contained in a cart 30. Other elements, including the optical components of the apparatus are contained in a printer housing 32. These components are shown in further detail in FIGS. 2 and 3A-3B. Cart 30 is fitted with casters 36 or other wheels and is configured to fit within an opening 34 in a front side of printer housing 32. The other wheels can be, but are not limited to, Mecanum or omni wheels, which allow the cart to drive sideways, decreasing the amount of space required for the carts to maneuver. When the cart 30 is housed within opening 34, a cover 40 rolls back thereby exposing the powder bed 12, and the trays for powdered medium 10 and screw jacks 38 deploy, bringing powder bed 12 and the trays for powdered medium 10 to their operational positions within the printer housing 32. FIG. 3B shows the completed assembly. After printing processes have been completed, or the powder in cart 30 expended, the screw jacks 38 recede, lowering cart 30 onto the casters 36 and the cover 40 is rolled out to cover the powder bed 12 and the trays for powdered medium 10. The cart 30 then exits the printer housing 32.

The cover 40 can have an integrated heating element, for example a resistive heater, in order to maintain the temperature of the powder bed 12 after the cart 30 has been expended from the printer housing 32. With the increase of speed of printing, the ratio between the time of printing and the time of cooling after the printing has decreased, meaning the bulk material after the printing process requires more time to cool down than it took to print it. After the printing process, the cart 30 may dock into one of a plurality of supply area stations, where batteries used to power the cart may undergo recharging and the heating elements may run off outlet connections instead of batteries. With such a modular design, it is preferable that multiple printer carts 30 can dock into one printer housing 32, increasing the overall printing throughput. The printer housing 32 can request a next available printer cart 30 from a pool of carts stationed at the supply area. The printer carts 30 can be dedicated to work with only one type of material, reducing the time needed to clean and prepare the carts 30 between prints.

Note that in the above-described embodiment, the cart 30 includes both the trays for the powdered medium 10 and the printer bed 12. However, in other cases, the printer cart 30 includes only printer bed 12, while the trays for the powdered medium 10 (with the powdered media therein) are included in the printer housing 32. In some embodiments, cart 30 is an autonomous or semi-autonomous vehicle and performs its actions at the request and control of the printer housing 32 and/or a remote controller.

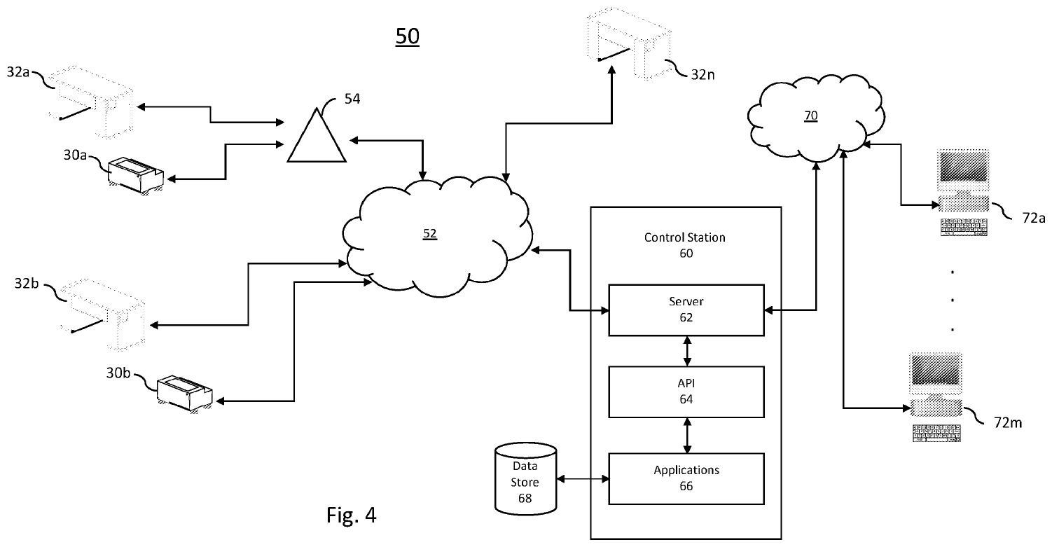

Referring now to FIG. 4, an example of a system 50 that integrates multiple printer housings 32a-32n, carts 30a-30b, and a control station 60 where telemetry from each of these devices is received and processed and commands transmitted via one or more networks or network of networks 52 is shown. Optionally included as part of the control station 60 are one or more client stations 72a-72m, each communicably coupled to the remote station 60 by one or more networks or network of networks 70 and at which the operations and actions of the printer housings 32a-32n and carts 30a-30b can be viewed, assessed, and controlled. Some or all of the components of network 70 may be part of network 52 or they may be separate networks or networks of networks. A repeater unit 54, which may be stationary or mobile, is shown as providing a communication path for printer housing 32a and cart 30a to network 52. In practice, multiple repeater units may be used for such purposes to accommodate multiple printer housings and carts. Although only discrete numbers of printer housings, carts, client stations, and other components of system 50 are illustrated, in practice, instantiations of the system 50 may have any number of such devices included. Likewise, although the control station 60 is shown as a single unit, in practice the functions of the control station 60 may be distributed over a number of computer systems, for example, cloud-based computer systems that include multiple virtual machines running on a number of physical compute devices. The illustration of system 50 should, therefore, be regarded as illustrative for purposes of the present description and not limiting in terms of the physical composition thereof.

In this illustrated embodiment, system 50 includes multiple printer housings, carts and a control station, as well as means for intercommunication amongst these units. The printer housings and carts may be of the kind described above and include audio/video means (e.g., cameras, microphones, etc.) to capture audio/video information to transmit that information to the control station 60. Also included are location sensors, e.g., GPS or similar units, to provide location information concerning the respective printer housings and carts. In some instances, the carts and printer housings are located within a facility that has adhesive magnetic tape affixed to the floor. Alternatively, optical tracking of floor path indicators may be used. The printer housings 32a-32n are located at known coordinates, and the carts 30a-30b are automated guided vehicles that include magnetic guide sensors. At the instruction of the control station 60, or one of the printer housings 32a-32n, a cart will proceed to dock with a printer housing by following the lines of magnetic tape on the floor using its magnetic guide sensors. Electric motors may power one or more of the castors to propel the cart to its destination. When not in use at a printer housing, carts may be stationed at a supply area, e.g., where batteries used to power the electric motors may undergo recharging. At the control station 60, one or more client stations 72a-72m act as receiving and presentation stations to provide views of the data concerning the monitored carts and printer housings as well as the printing operations being performed at the printer housings.

Besides a supply area, another destination for a printer cart can be a post-processing station, where, similarly to a printer housing, a printer cart 30 can dock to perform unpacking, de-powdering, cleaning of printed parts, and/or refilling of the trays with the powdered medium. The de-powdering station can be operated manually by a technician or may be fully automated.

Refilling can be done with the aid of the control station 60. For example, a material container may be labeled with a unique code to be scanned, before the powdered material is filled into a tray within the cart. The code may then be provided to the control station 60, where it is logged along with the type and amount of material in each printing cart 30a-30b. As print operations are performed, the control station keeps track of the various printer carts 30a-30b, recording which carts are empty and need refilling, and which have enough of the right powdered material to finish the various printing jobs. This helps prevent print jobs from starting with carts that are not fitted with the right type and/or sufficient amount of material.

In general, the communications between printer housings 32a, 32b, 32n, carts 30a-30b, and control station 60 may be wireless radio frequency (RF) communications, at least in part. For example, the respective telemetry units of the printer housings 32a, 32b, 32n and carts 30a-30b may include RF transceivers to transmit and receive audio/video information to/from the control station 60. In some cases, when a cart is docked with a printer housing, the cart may be configured to make use of the telemetry unit of the printer housing, for example using a local, short-range wireless communications connection thereto and/or a local wired communications connection thereto.

In system 50, the carts 30a-30b and printer housings 32a-32n may be configured to form a wireless ad hoc network, such as a mesh network, amongst some or all of them to wirelessly transmit data concerning the respective local environment to control station 60 via network 52. Each printer housing 32a-32n and cart 30a-30b may be associated with a unique identifier that can be associated with data transmitted by the respective device in order to correlate that information with a specific device and location at the control station 60. In this way, data transmissions from the shop floor may be more robust than if communications were dependent upon transmissions from individual units, as multiple wireless connections to network 52 between the devices provide redundancy in such a topology. So too may repeater 54 act as a relay station for one or more carts 30a-30b and/or printer housings 32a-32n.

Within control station 60, one or more computing devices communicatively coupled to network 52 hosts a server 62, such as an HTTP server, and an application 66 that implements aspects of the system 50 in accordance with embodiments of the present invention. Application(s) 66 may perform coordination and analytics on data received from the printer housings and carts, (and other devices, e.g., GPS units that provide location information, remote-piloted drones that provide shop floor audio/video views, etc.) and store same in a data store 68. Data store 68 may be a dedicated storage appliance or may be cloud-based storage accessible to the computing devices that make up the remote station.

Application(s) 66 may support an Application Programming Interface (API) 64 providing external access to client stations 72a-72m for accessing live audio/video feeds from the printer housings 32a-32n and carts 30a-30b, and/or from remote data store 68 via server 62. In certain embodiments, client applications such as web browsers running on client stations 72a-72m may access application(s) 66 via API 64 and through server 62 using protocols such as HTTP (hypertext transfer protocol) or FTP (file transfer protocol). In certain embodiments, various client stations may be a laptop or desktop computers, mobile devices such as smart phones, or wearable devices such as a virtual reality player.

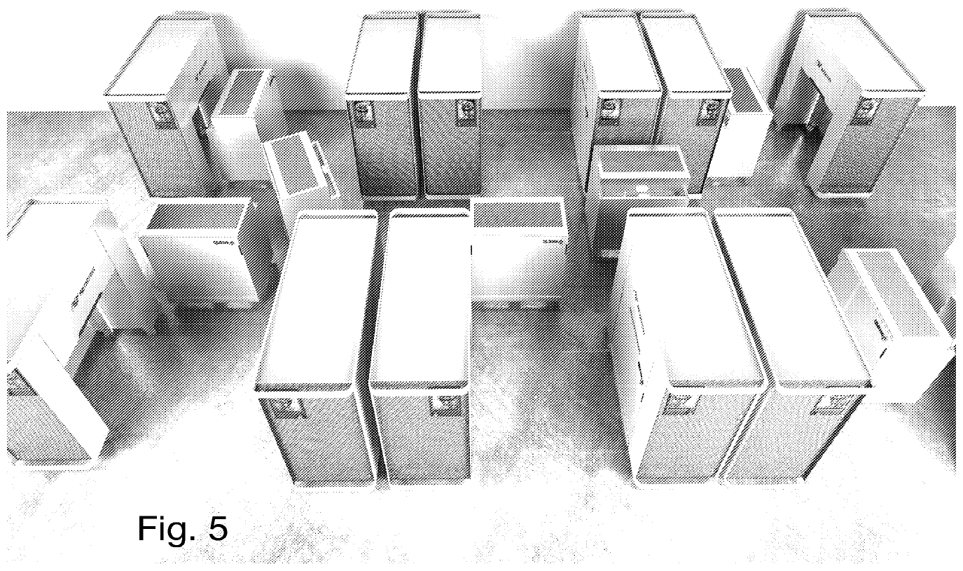

The present system is suitable for controlling and monitoring the operations of a shop floor such as that illustrated in FIG. 5. In such an environment, multiple printer housings and carts are coordinated to perform a variety of print operations. Printer housings may call for carts directly or through the control station. A requested cart is dispatched from a stand-by area and navigates to the requesting printer housing autonomously using its magnetic guide sensors to follow lines of magnetic tape on the floor. At the requesting printer housing, the cart docks, moves the powdered media trays and powder bed into position by elevating on its jack screws, and printing operations commence. As the cart becomes empty of powdered media, it decouples from the printer housing and returns to the stand-by area where it is refilled with powdered media, and its batteries are recharged. Many different printing operations can be run simultaneously in such an environment.

At the control station, the audio/video information from the printer housings and the telemetry data from the carts is received by server 62 and passed to application(s) 66 via API 64. Application(s) 66 begin recording and storing the audio/video information and/or telemetry data to data store 68 for archival and training purposes. In addition, application(s) 66 provide a feed of the audio/video information and telemetry data to one or more of the client stations 72a-72m, where it can be viewed by persons manning those stations.

The client stations may be equipped with one or more displays on which the information from the printer housing 32a-32n and carts 30a-30b is displayed. The client stations are also configured to allow the operators to control the printing processes, the carts, and other operational aspects of the system. Thus, powder bed carts and associated printer housings for a selective laser sintering (SLS) and, in one embodiment, such carts with means for autonomous locomotion and docking with ones of said printer housings, have been described.

What is claimed is:

1. A powder bed cart for a selective laser sintering (SLS) apparatus, the powder bed cart comprising:
a powder bed;
means for autonomous locomotion; and
means for docking with a printing housing of said SLS apparatus.

2. The powder bed cart of claim 1, wherein the means for autonomous locomotion comprises:
location sensors;
wheels disposed on an underside of the powder bed cart;
an electric motor to steer and propel the powder bed cart to a desired destination; and
batteries for powering the electric motor.

3. The powder bed cart of claim 1; wherein the means for docking with the printing housing comprises vertical adjustment means to raise a vertical position of the powder bed to an operational position within the printer housing.

4. The powder bed cart of claim 1, wherein the powder bed is covered by a retractable cover.

5. The powder bed cart of claim 4, wherein the retractable cover comprises an integrated heating element in order to maintain a temperature of the powder bed.

6. The powder bed cart of claim 1, wherein the powder bed cart is configured to be docked in a supply area station, where batteries of the powder bed cart undergo recharging and heating elements of the powder bed cart run off outlet connections instead of the batteries.

7. The powder bed cart of claim 1, further comprising one or more trays for holding a powdered material.

8. The powder bed cart of claim 7, wherein the powder bed cart is configured to be docked in a post-processing station, where the powder bed cart performs at least one of unpacking, de-powdering, cleaning of printed parts or refilling of the one or more trays with the powdered material.

9. A printer housing for a selective laser sintering (SLS) apparatus, the printer housing comprising:
an opening adapted for docking with an autonomous powder bed cart for said SLS apparatus, the autonomous powder bed cart comprising a powder bed;
a laser source configured to generate a laser beam; and
an imaging system configured to scan the laser beam over powdered material disposed in the powder bed, causing the powdered material to form a solid mass at points heated by the laser beam.

10. The printer housing of claim 9, further comprising one or more trays for holding the powdered material.

11. The printer housing of claim 9, wherein the opening is adapted for docking with a plurality of autonomous powder bed carts.

12. The printer housing of claim 9, further comprising a roller configured to spread the powdered material within the powder bed.

13. The printer housing of claim 9, wherein the printer housing is configured to transmit a request to the autonomous powder bed cart, requesting the autonomous powder bed cart to travel from a stand-by area to the opening of the printer housing.

14. The printer housing of claim 9, further comprising a telemetry unit configured to transmit and receive audio and/or video information to and from a control station.

15. A selective laser sintering (SLS) printing system, comprising:
a first plurality of autonomous powder bed carts;
a second plurality of printer housings, each printer housing adapted for docking with one or more of the first plurality of autonomous powder bed carts; and
a control station communicably coupled to the first plurality of autonomous powder bed carts and second plurality of printer housings so as to control operations of the first plurality of autonomous powder bed carts and the second plurality of printer housings.

16. The SLS printing system of claim 15, wherein the control station is configured to transmit a request requesting one of the first plurality of autonomous powder bed carts to travel from a stand-by area to an opening of one of the second plurality of printer housings.

17. The SLS printing system of claim 15, wherein the control station is configured to maintain a record of a type and amount of material in each of the first plurality of autonomous powder bed carts.

18. The SLS printing system of claim 15, wherein the control station is configured to receive audio and/or video information from one or more of the first plurality of autonomous powder bed carts or the second plurality of printer housings.

19. The SLS printing system of claim 18, wherein the control station is configured to transmit the audio and/or video information to one or more client stations.

20. The SLS printing system of claim 15, wherein the control station is configured to receive commands from one or more client stations, the commands configured to control the operations of the first plurality of autonomous powder bed carts and the second plurality of printer housings.
